(19) United States
(12) Patent Application Publication
(10) Pub. No.: US 2007/0097917 A1
(43) Pub. Date: May 3, 2007

(54) Method for rapidly lnking mobile node and access point in wireless local area network

(75) Inventor: Chi-Cheng Kang, Kaohsiung City (TW)

Correspondence Address: BIRCH STEWART KOLASCH & BIRCH, PO BOX 747, FALLS CHURCH, VA, 22040-0747, US

(73) Assignee: Institute for Information Industry

(21) Appl. No.: 11/341,644

(22) Filed: Jan. 30, 2006

(30) Foreign Application Priority Data
Nov. 2, 2005 (TW) 094138474

(51) Int. Cl. H04Q 7/00

(52) U.S. Cl. 370/331; 370/338

(57) ABSTRACT

A method for rapidly updating network information when a mobile node (MN) moves in a wireless local area network (WLAN) is provided, wherein the MAC Table information in a wireless LAN switch can be rapidly updated or removed when hand-off has been completed for the wireless LAN switch in the MN, such that the problem of forwarding a data packet to an incorrect position when Layer 2 packet switching is carried out for each switch in the WLAN can be avoided, and the problem of non-successive data packets or packet loss can be avoided as well.

### CROSS-REFERENCE TO RELATED APPLICATIONS

This non-provisional application claims priority under 35 U.S.C. § 119(a) on Patent Application No(s). 094138474 filed in Taiwan, R.O.C. on Nov. 2, 2005, the entire contents of which are hereby incorporated by reference.

### BACKGROUND OF THE INVENTION

1. Field of Invention

The present invention relates to a method for carrying out Layer 2 packet switching in a wireless local area network (WLAN), and more particularly relates to a method for rapidly updating network information when a mobile node (MN) moves in a WLAN.

2. Description of Related Art

In a general local area network (LAN) environment, a switch supports a MAC Bridge (IEEE802.1d), and carries out a rapid Layer 2 packet switching through using a MAC Table therein. When there are multiple switches connected in parallel and serial, IEEE 802.1d Spanning Tree Protocol (STP) or IEEE 802.1w Rapid STP (RSTP) algorithms are generally utilized to detect the network environment, in order to avoid generating loops in the network environment and causing chaos in the MAC address record.

The same IEEE standard protocols and algorithms are used in a WLAN environment, and when a mobile device (e.g., PDA, Notebook) in the WLAN moves between different access points (APs), staged network connection failure, non-successive packet, or packet loss may occur, as shown in FIGS. 1A˜1C.

In FIG. 1A, before a mobile node (MN) 10 moves, a sender 20 successively sends data packets to a first wireless access switch 30, and the MN 10 receives the data through the first wireless access switch 30.

In FIG. 1B, the MN 10 moves within range of a second wireless access switch 40. Although after moving the MN 10 is no longer within the range of the first wireless access switch 30, since the MAC record related to the MN in the MAC Table information, according to which each switch in the LAN carries out the Layer 2 packet switching, has not yet been updated or removed, the data packets sent by the sender 20 will still be forwarded to the first wireless access switch 30 after the Layer 2 packet switching process in the LAN, thereby data packet loss will occur.

In FIG. 1C, only after the MAC Table information in each switch of the LAN is updated actively or is replaced passively when overdue, can the data packet be successfully sent to the second wireless access switch 40 by the sender 20, and then the MN 10 can receive the data through the second wireless access switch 40.

In a LAN environment, the switch generally supports the MAC bridge (IEEE 802.1d) function, which mainly includes two parts:

1. MAC Table

The MAC Table provides the functions of MAC address recording and learning, to avoid repeatedly broadcasting a data packet with a MAC address position of known destination, wherein the MAC Table information for each record has its own effective time limit. If the data packet from the MAC address is not received again within the time limit, this recorded information will become overdue and is removed, thus preventing recorded information from getting too old to suit the real network topology, with the general predetermined overdue time limit as 30 to 300 seconds.

2. Spanning Trees algorithm

The Spanning Trees algorithm provides automatic detection of the LAN topology and prevents the network environment from generating loops. The typical spanning tree algorithms are, for example, Spanning Tree Protocol (STP), or Rapid STP (RSTP), etc., and the network administrator can optionally select STP, RSTP, or no algorithms will be employed.

With the information of the MAC Table, the Layer 2 rapid packet switch can be carried out accordingly, to avoid the deterioration of the network loading performance caused by the circumstance that all packets need to be sent to the CPU. But as for a WLAN environment with many MNs as if anticipating, if the old incorrect information cannot be rapidly updated or removed from the MAC Table information as the MN moves, the data packet might be switched to an incorrect position through rapid packet switching by the switch, thus causing packet loss during the moving process.

In the general wired local area network environment, the connection failure when the user moves surely do occur, with the only difference being in that in the wired environment the moving action involves plugging in/out of network cables and even resetting parameters, and the reconnecting action is generally considered as normal. However, in the wireless networks, there are no obviously similar network On-Off actions while a user moves; thus it is expected by the user that the network connection can be maintained.

In view of the above problems occurred when an MN moves in the WLAN, the way of communication connection to Internet service are discussed in depth, and there are mainly three situations when an MN moves:

Situation 1: As shown in FIGS. 2A˜2C, after the MN 10 moves, the packets are not actively sent out, or the packets are sent after the overdue time limit has elapsed. Within the overdue time limit, each switch carries out the packet switching with the old MAC Table information, such that the packets are all forwarded to incorrect positions within the time limit, resulting in packet loss. The packets can be correctly forwarded to the MN only after the old information is removed when the overdue time limit has been reached. Most of the user terminals of this type of network service are generally in a data receiving state, and there is a certain time interval for the controlling messages to be sent back to the sender 20, for example, digital video conference, video on demand, digital broadcasting, the sending and receiving of large files or mails, and the like.

Situation 2: After the MN moves, the packets are actively sent out within the overdue time limit of the MAC information. This situation is similar to Situation 1, only except that the response message is happen to be sent back to the sender within the overdue time limit; however, during the time period from the beginning of the moving process to the sending of response message actively by the MN, the data packets sent by the sender will still be lost, with the difference being in that the time period of the packet loss is not as long as that of Situation 1 which is the whole overdue time limit.

Situation 3: As shown in FIGS. 3A˜3C, after the MN 10 moves, the packet is sent out actively in time or immediately before the sender 20 sends the next packet. Since after the MN 10 moves, the packet is sent out actively in time or immediately before the sender 20 sends the next packet, to update the MAC Table information on the switch of the LAN, packet loss can be avoided. This kind of network service will generally send a request message actively before a user terminal requires to obtain or update the data, for example, webpage browsing, online game, sending and receiving small files or mails, and the like.

Therefore, it has become a hot issue to design a method for rapidly updating the network information when a MN moves in a WLAN, in accordance with the possible situations of the moving action of MN in the above WLAN.

### SUMMARY OF THE INVENTION

In view of the above problem, an object of the present invention is to a method for rapidly linking a mobile node and an access point in a WLAN, such that the wireless LAN switch supporting this method can rapidly update or remove the MAC Table information on the switch when hand-off has been completed for the MN. Therefore, the problem of forwarding data packets to incorrect positions when carrying out the Layer 2 packet switch by each switch in the LAN can be avoided, and data packet loss can be avoided as well.

The present invention provides two embodiments, wherein the first embodiment utilizes the Network Topology Change Notify, a notification is actively sent by the wireless LAN switch originally accessed by the MN (before moving)to remove all the MAC Table information to be send towards this direction in the switch of the LAN; the second embodiment utilizes the MAC Proxy Process, and a proxy notification is actively sent by the wireless LAN switch newly accessed by the MN (after moving) to update the MAC record of the MN of the MAC Table information in all switches of the LAN. The above two embodiments are both carried out actively by the wireless LAN switch, and both of them can solve the problem of packet loss during the linking of the MN and the AP, except, that the operation points are different. It is suggested that the two embodiments are utilized simultaneously, such that the wireless LAN switch can be used more flexibly, and old empty files of the MAC Table can be efficiently reduced, to prevent the data packet from being forwarded to an incorrect position.

The detailed features and advantages of the present invention will be described in great detail in the embodiments, and the content is sufficient for any of those skilled in the art to understand the technique of the present invention and implement accordingly. And any advantage and object related to the present invention can be easily appreciated from the disclosure, claims, and accompanying drawings of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only for, and thus are not limitative of the present invention, and wherein:

FIGS. 1A˜1C is a schematic view of the conventional packet loss for a mobile node (MN) in a wireless local area network (WLAN);

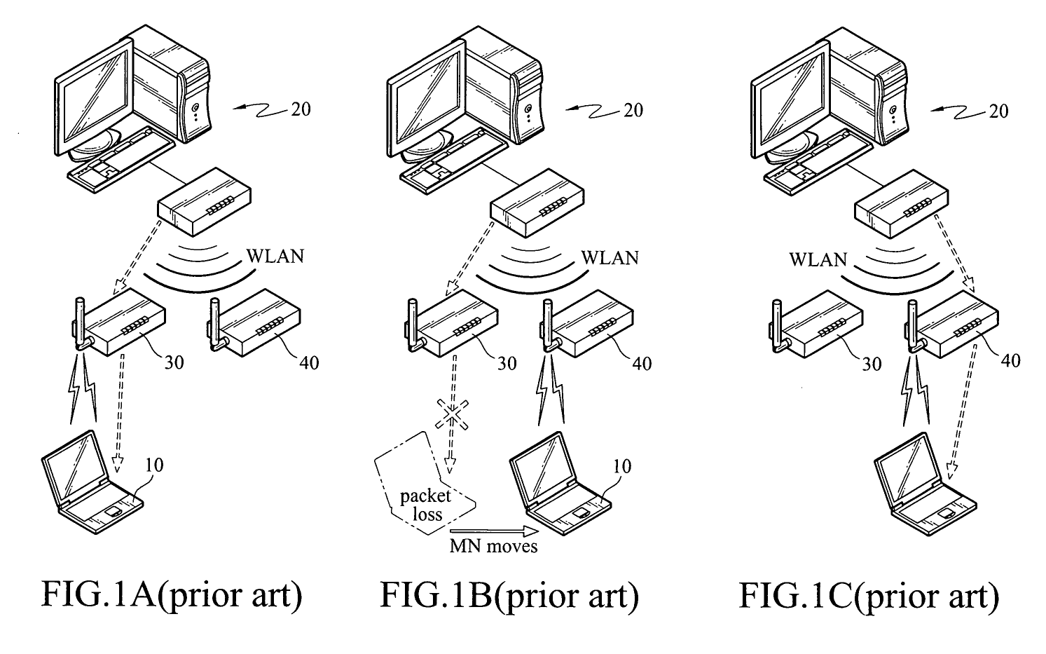

FIGS. 2A˜2C is a schematic view of conventionally not sending a packet actively or sending the packet after the overdue time limit has elapsed, after the MN moves in the WLAN;

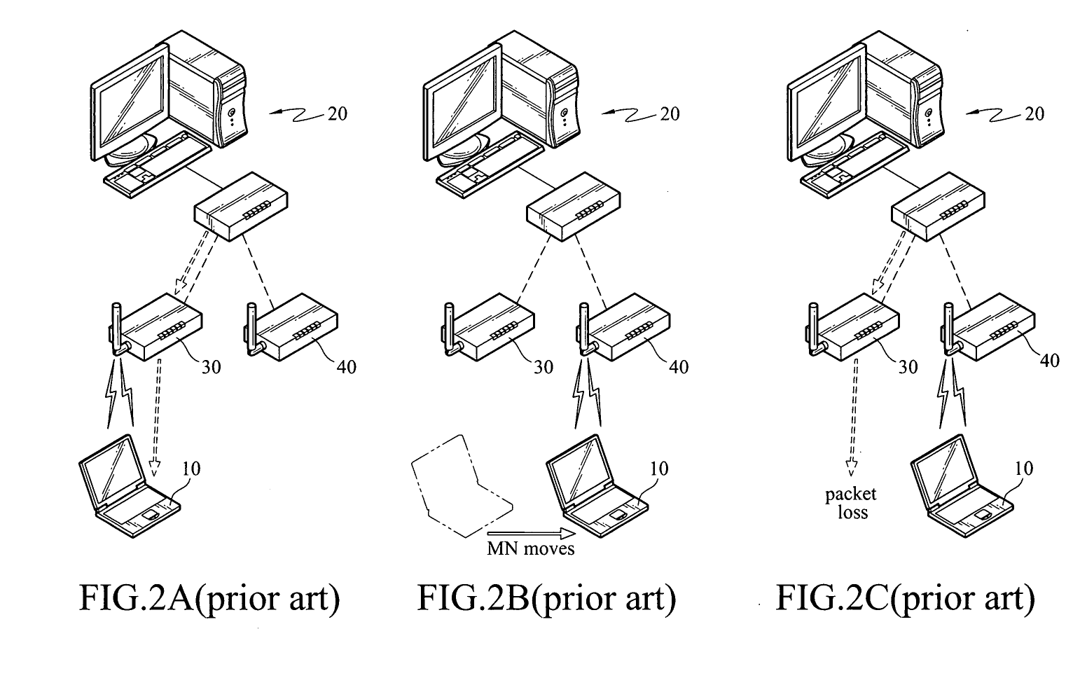

FIGS. 3A˜3C is a schematic view of conventionally sending a packet in time or immediately before the next packet is sent by the sender, after an MN moves in a WLAN;

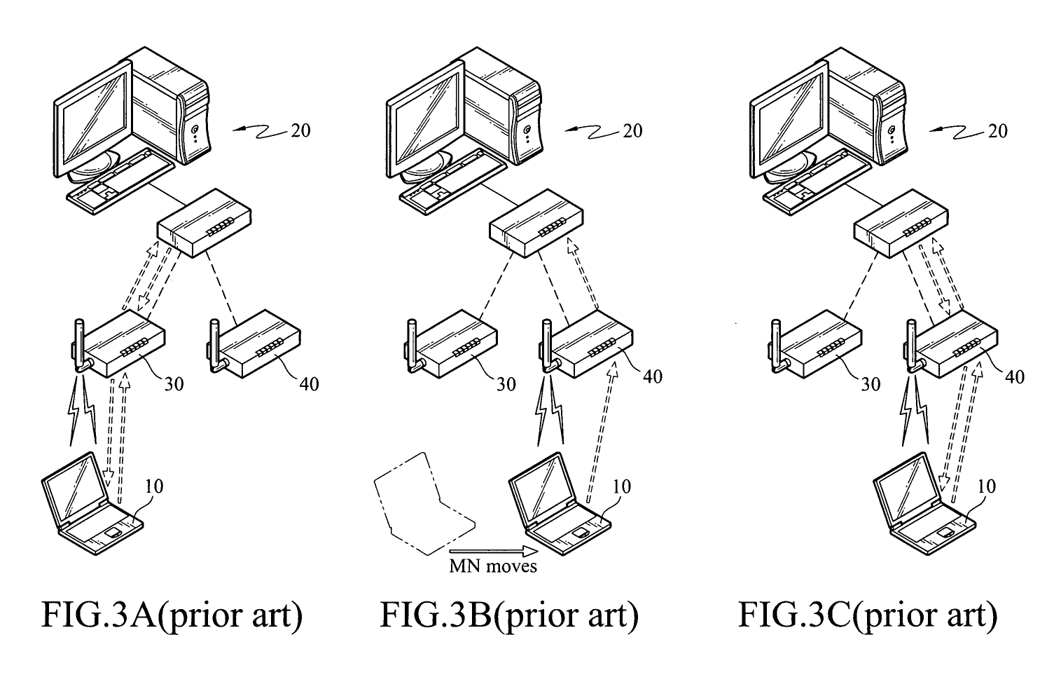

FIG. 4 is a flow chart for a first embodiment of a method for rapidly linking an MN and an AP in a WLAN according to the present invention;

FIGS. 5A˜5Bis a schematic view of the first embodiment of the present invention;

FIGS. 5C˜5D is the other schematic view of the first embodiment of the present invention;

FIG. 6 is a flow chart for a second embodiment of a method for rapidly linking an MN and an AP in a WLAN according to the present invention;

FIGS. 7A˜7B is a schematic view of the second embodiment of the present invention;

FIGS. 7C˜7D is the other schematic view of the second embodiment of the present invention; and

FIG. 8 is a schematic flow chart of the suggestion of combining the two embodiments in the present invention.

### DETAILED DESCRIPTION OF THE INVENTION

The features and practice of the present invention will be described in great detail in preferable embodiments with reference to the accompanying drawings.

The implementation of the present invention may be excluded in the following two preconditions. (1) Generally, local area network (LAN) environment is considered to be within a sub-network with a same IP, i.e., there is no need for reacquiring or resetting the IP address, which belongs to the issue of Layer 3 hand-off or IP Mobility. (2) Supposing that the RF of the wireless environment supports Seamless hand-off, i.e., the time difference for RF switching is within an acceptable range, and the time difference for hardware RF switching is not considered.

It can be known from the above description, if the recorded information of the MAC Table can be updated in time within an acceptable time interval, the packet loss occurring when an MN moves in the WLAN can be reduced as much as possible; and if the MAC Table information is desired to be updated at an higher speed, there are mainly two embodiments as follows.

The first embodiment: The MAC Table is passively removed by waiting for the overdue time period. An overdue time limit can be simply set to be shorter directly, such as 1 second. However, a very short overdue time limit also indicates that the record information will soon be removed, such that the data packet to be packet switched can only be processed by the way of broadcasting, with an attempt to learn the MAC address, since no record can be found. What has been learned will also be removed soon, thus almost every data packet is sent by way of broadcasting. It seems that there is no function of the MAC bridge (IEEE 802.1d), and network resources are also wasted. Besides the above method, the overdue time limit can be triggered in advance through the cooperation of the spanning tree algorithm, which is called the Topology Change Notify (TCN) method.

The second embodiment: The MAC Table is actively updated by receiving data packets. Although it is impossible to request that the user terminals (mobile nodes) all over the world send controlling message packets to update the MAC table information of the switch at each movement, it can be achieved through another approach, which is called the MAC Proxy method.

The above problems can be solved in both methods of the above two embodiments. Although the packet loss cannot be completely avoided, it can be controlled and reduced to within an acceptable range; and in some network services, the packet loss can even be completely avoided.

The two embodiments mentioned above are described in great detail below.

[First Embodimemt]

The TCN method: For deleting MAC Table information, besides the overdue limit of the record, when the network topology changes in the spanning tree algorithm, a Bridge Protocol Data Unit (BPDU) containing a change notification information will be sent in the protocol operation, to require the other switches to clear all the MAC Tables related to the link ports that have received this BPDU. It should be noted that, the determined network topology change herein means the transaction of a switch of the LAN, excluding the common end-user device (the device does not execute the spanning tree protocol). The MN belongs to a common end-user device, which cannot connect to an independent Basic Service Set (BBS, i.e., ad-hoc environment) if it supports 802.11 as specified by 802.1d. In the wired environment, each of the switches is generally connected to each of the other devices through the respective link port; therefore, whether or not a topology change has occurred can be determined according to the LinkUp/LinkDown corresponding to the link port. However, in a wireless environment, the RF of a wireless access point is like a Hub, which is always activated to wait for the accessing link of the terminal device, thus there will be no change in the RF linking state, but the statistics of the current access devices and the basic information.

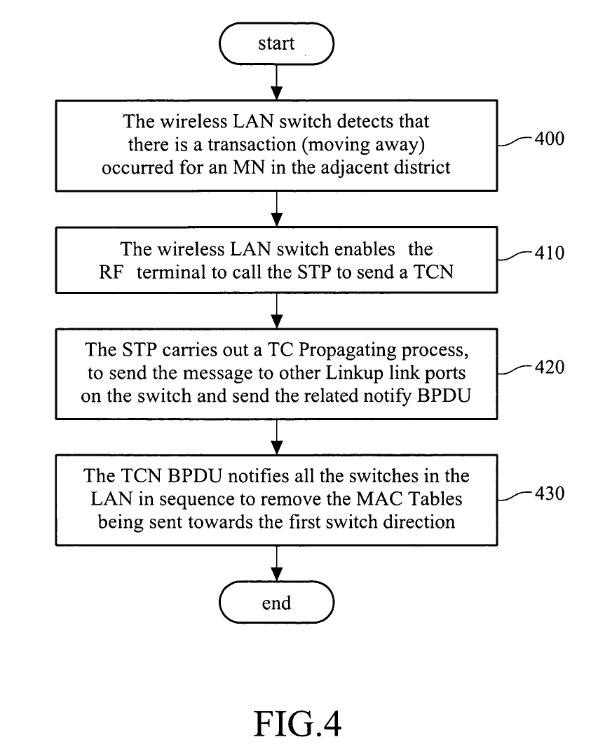

Referring to FIG. 4, it is a first embodiment of a method for rapidly updating the network information when a MN moves in a WLAN, which includes the following steps. The wireless LAN switch detects that there is a moving transaction occurred for a MN in the adjacent district (Step 400). The RF terminal of the wireless LAN switch calls the STP to send a TCN actively (Step 410). The above two steps are carried out through monitoring the RF access device statistics and basic information, such as the current connection number and the MAC address of the access device, etc. And once it is detected that the access device moves to another access point (the MAC address recorded at the RF terminal will be removed), the STP will be notified to trigger the RF terminal to carry out the transaction process. It is suggested that the monitoring process is added to the RF terminal driving program, that is, the wireless access information can be obtained actively, to avoid external modules being used for inquiring at a fixed time. The STP will set STP algorithm of the RF terminal as the TC and carry out the TC propagating process, once it receives the transaction notification of removing the RF terminal records, to notify the change to other LinkUp link ports on the wireless LAN switch and send out the related notify BPDU (Step 420). All switches in the LAN will be notified in sequence by the TCN BPDU, and the MAC Table to be sent towards the first switch direction is removed (Step 430), wherein the TC propagating process is carried out by way of broadcasting; the TCN BPDU will be used if the STP is employed; and the RST BPDU with the set TC-flag will be used if the RSTP is employed.

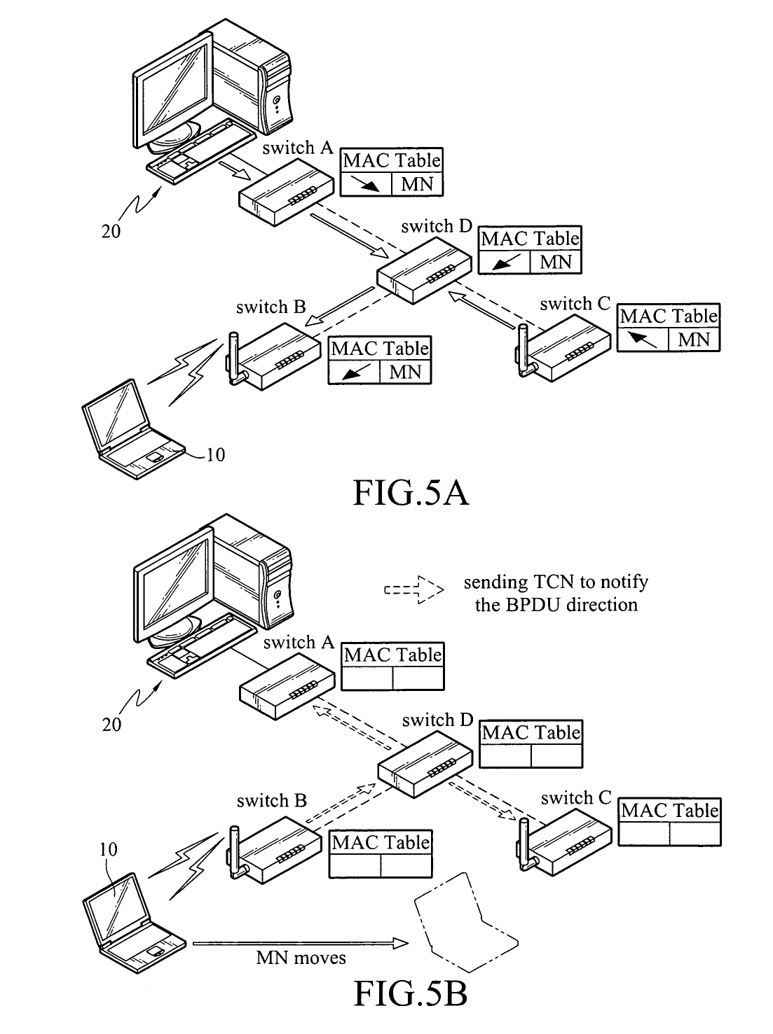

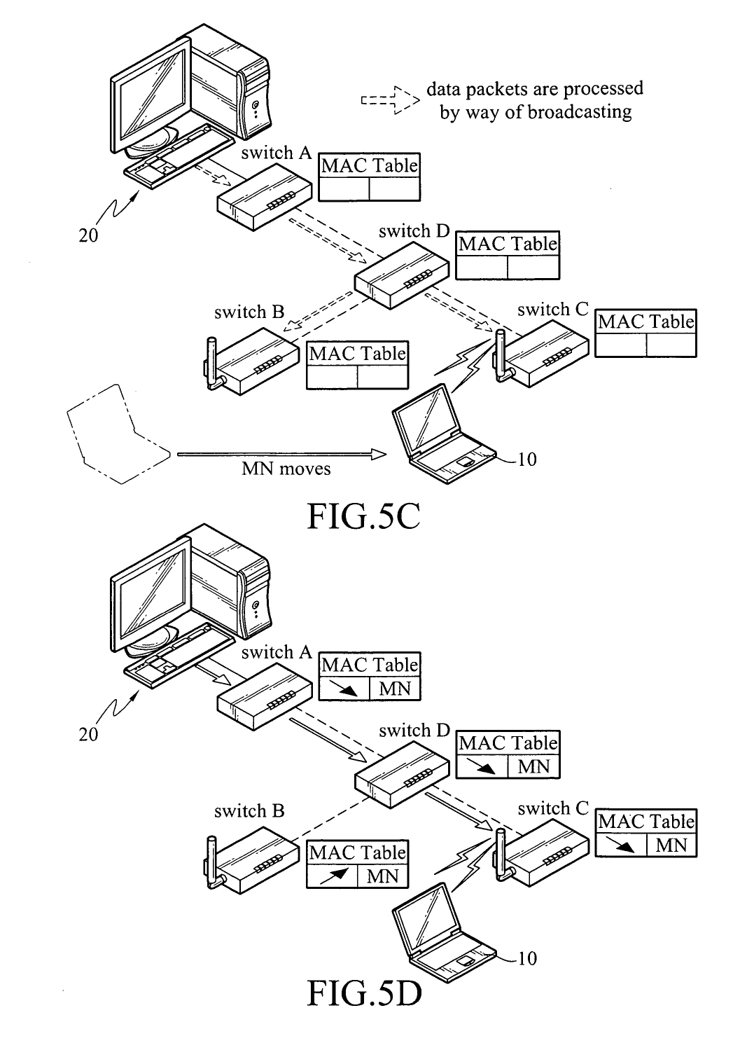

According to the steps of the above embodiment, the operation examples of the TCN method are as shown in FIGS. 5A˜5D.

As shown in FIG. 5A, the MAC Tables in the switches A, C, and D to be sent to the MN 10 are all towards to the direction of switch B.

As shown in FIG. 5B, when the MN 10 is to move from the switch B to the switch C, the RF terminal of the switch B detects the transaction, and notifies the STP to send the TCN BPDU actively, and all the switches in the LAN are sequentially notified to remove the MAC Tables towards the switch B direction.

As shown in FIG. 5C, when the sender 20 is to send data packets to the MN 10, the data packets are processed by way of broadcasting, since each switch currently has no MAC Table of the MN 10.

As shown in FIG. 5D, when the MAC Table of the MN 10 has been learned by the switches in the LAN, it can be directly transferred to the MN 10 within the range of the switch C.

In this way, the problem that the MAC Table cannot be updated in time in a WLAN environment is solved. However, there is a disadvantage for this approach: the removed MAC Tables through using the TCN mechanism of the STP not only includes the MAC Table for the MN 10, but all the other MAC Tables for each switch towards the switch B direction, such that other communication connections, which are still needed to be sent to switch B, have to learn the MAC Table once more; and before that, the data packets will be temporarily processed by way of broadcasting. [Second Embodiment]

The MAC Proxy method: Although it is impossible to force the user terminals (MN) all over the world to send packets actively to update the MAC Table at each moving action, it can be processed through the ARP Proxy mechanism or the concept of the Binding Update program of IP Mobility, wherein the packets are sent out by the wireless LAN switch instead of the MN for updating the MAC Table, thus this approach is called the MAC Proxy method. This method can be conducted directly with the statistics and basic information of the access device recorded in the RF terminal of the wireless LAN switch, without using Spanning Trees or other algorithm protocols.

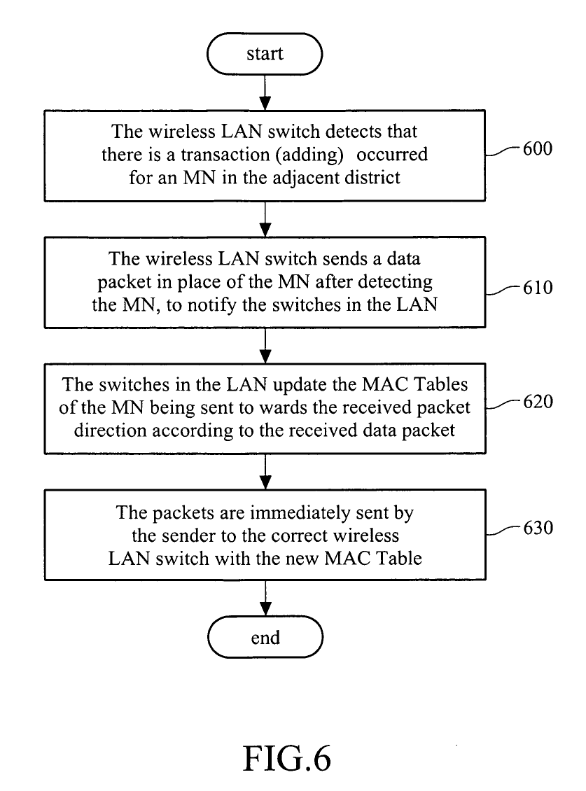

Referring to FIG. 6, it is a second embodiment of a method for rapidly updating the network information when a MN moves in a WLAN, which comprises the following steps. The wireless LAN switch detects that there is an adding transaction occurred for a MN in the adjacent district (Step 600). After the wireless LAN switch detects the MN, it sends data packets actively instead of the MN, to notify all the switches in the LAN (Step 610). The above two steps are carried out through monitoring RF access device statistics and the basic information, such as, the current connection number and the MAC address of the access device, etc. If it is detected that there is a new access device requiring addition to the district covered by the wireless LAN switch (the MAC address recorded at the RF terminal will be added), a packet proxy sending program will be carried out actively. This monitoring process is suggested to be added to the RF terminal driving program, that is, the RF information can be obtained actively, thus avoiding external modules to be used for inquiring at a fixed time. When the wireless LAN switch carries out the data packet proxy sending program, all of the link ports at Forwarding state need to send data packets, besides the RF terminal, to notify each switch in the LAN actively; and the switches in the LAN receive the data packet and update the MAC Table of the MN towards the direction of the received data packets accordingly (Step 620). Then, the packets sent by the sender are packet switched with the new recorded information immediately, and are forwarded to the correct wireless LAN switch positions (Step 630); wherein the MAC address for the sending source of the proxy-sent data packet should be filled with the newly added MN MAC address obtained by the RF terminal, and the MAC address of the destination terminal should be filled with the unused (unlearned or cannot be learned) MAC address or the broadcasted MAC address. The packet content is not limited, as long as it is not the controlling messages that cannot be learned, such as, Layer 2 BPDU. It is suggested to use the ARP Query Message, even the customized format of the data message, which can be kept to extensively control the hand-off of the switch information in the LAN in future.

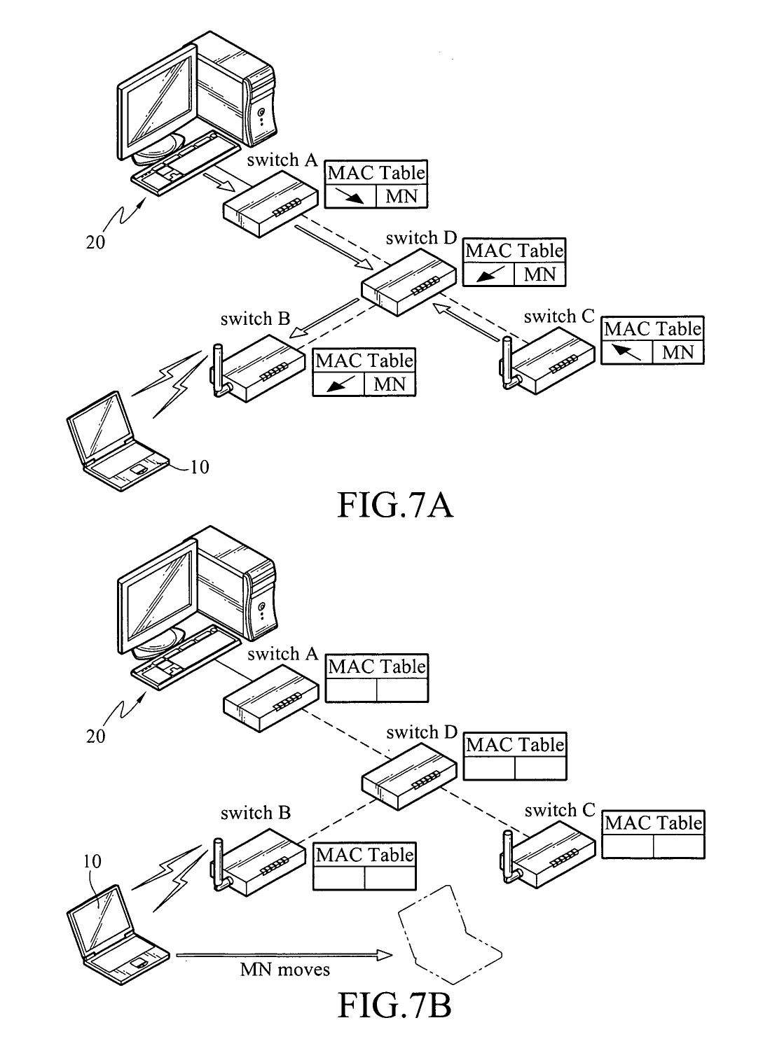

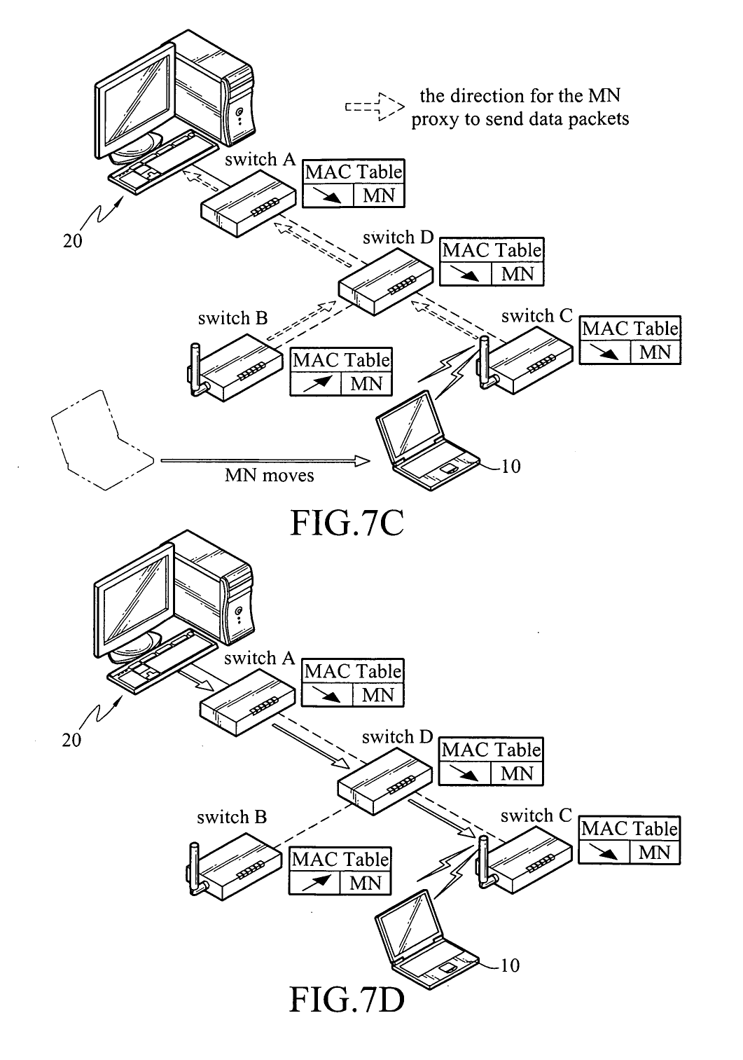

According to the steps of the above embodiment, the operation of the MAC Proxy method is, for example, as shown in FIGS. 7A˜7D.

As shown in FIG. 7A, the MAC Tables in the switches A, C, and D to be sent to the MN 10 are all towards the direction of switch B.

As shown in FIG. 7B, when the MN 10 is to move from switch B to switch C, the RF terminal of the switch B detects the transaction, but no process will be carried out.

As shown in FIG. 7C, the switch C sends the data packet in place of MN 10, to notify all switches in the LAN in sequence, and the MAC Tables will be directly updated from the switch B direction to the switch C direction.

As shown in FIG. 7D, when the data packet is to be sent by the sender 20 to the MN 10, it can be directly transferred to the MN within the range of the switch C without employing the broadcasting approach, since the MAC Table still can be inquired correctly.

In this way, the problem that the MAC Table cannot be updated in time in a WLAN environment can be solved. However, the updating of the MAC Table will be carried out, only after the adding of the MAC Table into the contemplating range for the new wireless LAN switch (switch C) has been completed. Thus, in this method, the empty window period of each switch keeping the old MAC Table is longer than that of the previous mechanism; of course, the probability of packet loss for this method will be higher than that for the above first embodiment.

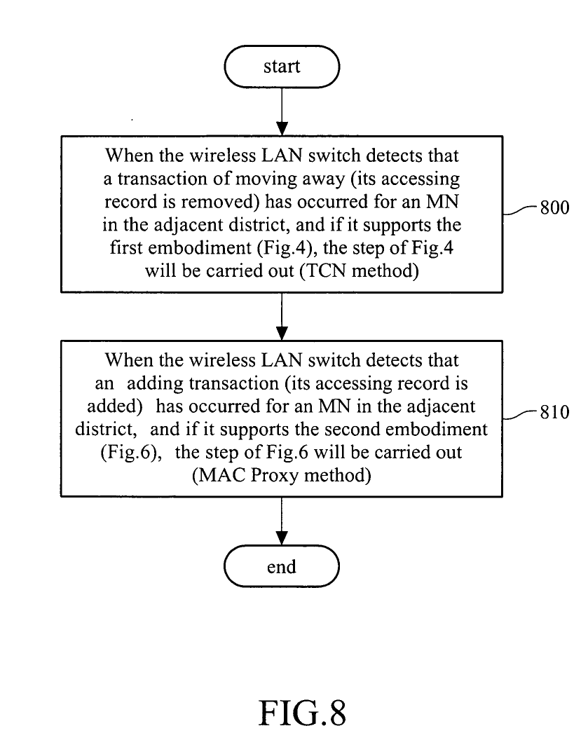

The above two disclosed embodiments both can address the problem that the MAC Table cannot be updated in time in a WLAN environment, but each has its advantages and disadvantages. Thus, it is suggested to employ the two embodiments simultaneously, as shown in FIG. 8, such that data packet loss can be minimized, and the rapid hand-off effect can be achieved to some extent, in the device itself or in the contemplated adjacent district when used with other devices that do not support the two mechanisms.

Moreover, if a virtual local area network (VLAN) is enabled in the WLAN environment, i.e., the MN 10 is a member of one VLAN. The first embodiment is changed to match with the multiple spanning trees protocol (MSTP) selected by changing the first embodiment, and the data packet added with a VLAN-tag being proxy sent in the second embodiment can be used together to be supported.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for rapidly updating network information through Topology Changing Notify (TCN) when a mobile node (MN) moves in a wireless local area network (WLAN), comprising the following steps:
detecting a transaction occurred for a MN in the adjacent district by a wireless LAN switch;
calling a Spanning Trees Protocol (STP) to send a TCN actively by a radio frequency (RF) terminal of the wireless LAN switch; and
carrying out a TC Propagating process by the STP, notifying the TCN to other LinkUp link ports on the wireless LAN switch, and sending a related notify Bridge Protocol Data Unit (BPDU).

2. The method as claimed in claim 1, wherein the wireless LAN switch is an access point (AP) in the WLAN.

3. The method as claimed in claim 1, wherein the step of detecting a transaction occurred for a MN by a wireless LAN switch means that the MN information recorded in the RF terminal will be removed.

4. The method as claimed in claim 3, wherein the MN information recorded in the RF terminal comprises MAC address information.

5. The method as claimed in claim 1, wherein the STP further comprises a rapid spanning tree protocol (RSTP).

6. The method as claimed in claim 1, wherein the TC Propagating process is carried out by way of broadcasting a notify BPDU.

7. The method as claimed in claim 1, in a virtual local area network (VLAN) environment, the processing step of using a multiple spanning tree protocol (MSTP) to replace the STP is further included.

8. A method for rapidly updating network information through MAC Proxy when a MN moves in a WLAN, comprising the following steps:
detecting a transaction occurred for a MN in the adjacent district by a wireless LAN switch;
sending a data packet actively in place of the MN by the wireless LAN switch after detecting the MN to notify the switches in the LAN; and
updating the MAC Table of the MN being sent towards the direction of the received packet by the switches in the LAN according to the received data packet.

9. The method as claimed in claim 8, wherein the wireless LAN switch is an AP in the WLAN.

10. The method as claimed in claim 8, wherein the step of detecting a transaction occurred for a MN by a wireless LAN switch means that the MN information recorded in the RF terminal will be added.

11. The method as claimed in claim 10, wherein the MN information recorded in the RF terminal comprises MAC address information.

12. The method as claimed in claim 8, wherein the step of updating the MAC Table of the MN is achieved through any non Layer-2 BPDU data packet broadcasting proxy.

13. The method as claimed in claim 8, wherein the data packet for updating the MAC Table of the MN is sent by a wireless LAN switch proxy.

14. The method as claimed in claim 8, wherein in the VLAN environment, the data packet sent by the proxy further comprises a VLAN-tag.
